(19) United States
(12) Patent Application Publication
(10) Pub. No.: US 2012/0111588 A1
(43) Pub. Date: May 10, 2012

(54) COMBINED VERTICAL AND HORIZONTAL TILLAGE WITH HARDPAN PENETRATION

(76) Inventors: TRAVIS R. SMITH, ALTON, IL (US); LEONARD R. SMITH, OMAHA, IL (US)

(21) Appl. No.: 13/215,530

(22) Filed: Aug. 23, 2011

Related U.S. Application Data
(60) Provisional application No. 61/409,959, filed on Nov. 4, 2010.

(51) Int. Cl. A01B 49/02; A01B 15/18; A01B 5/04

(52) U.S. Cl. 172/166; 172/540; 172/177

(57) ABSTRACT

An exemplary best mode embodiment and various alternative embodiments are shown for combining horizontal and vertical tillage to solve both weed control and penetration of compaction layer. In one exemplary embodiment a large colter or tine is disposed behind a plow, sweep, concave disc, or other horizontal tillage implement to slice the soil to penetrate any compaction created by the implement. In another exemplary embodiment, a colter with lateral blades penetrates a surface compaction layer, chops crop residue and hoes and levels the soil all in one pass with one implement. We have discovered that a deeper-penetrating tailing ground slicing implement behind a horizontal tillage device results in full root depth for a stronger crop and better yields with normally deep-rooted crops such as corn and the like.

### CROSS-REFERENCE TO RELATED APPLICATIONS

This is an original application.

### BACKGROUND

1. Field

This invention relates generally to farm implements, specifically to tillage implements and methods of their use.

2. Prior Art

Seedbeds have been prepared for centuries using horizontal tillage implements such as plows and sweeps. Plows work well to lift and turn soil and sweeps work well to horizontally slice weeds or crop residue and lift the soil. Both are known to compact an inch or two of soil immediately below due to downward pressure they necessarily exert while uplifting weeds and soil above. In addition, tractors passing over fields also compact soil at the surface down to about 4″. Since most plows and sweeps run at depths of 2-12 inches to till this surface compaction layer, it is not uncommon after horizontal tillage to have a 1-2″ compacted subsoil layer left 3-14″ below the surface of a horizontally tilled field. This subsoil compaction layer is called a “hardpan” as it acts like a cooking pan 3-14″ inches deep. Roots hitting this “hardpan” tend to go sideways and not penetrate. For shallow rooted crops this might not pose a problem, as the roots may not extend much deeper than that if unrestricted, anyway. However, corn and similar large plants have a normal unrestricted root depth of 5-8 feet but those roots have difficultly passing through hardpan, so yields can be significantly decreased by shallow rooting caused by hardpan. One current solution to this is to go to vertical tillage using chisel points, colters, reels, harrows, rotary hoes and the like and do away with plows and sweeps. However, since vertical tillage does not horizontally slice weed roots nor level the ground as effectively, vertical tillage is not as effective as horizontal tillage at removing weeds and preparing the soil for planting. Also, switching from horizontal to vertical tillage requires replacement of existing equipment with new equipment, which a farmer may not be in a financial position to do.

### SUMMARY

An exemplary best mode embodiment and various alternative embodiments of cultivators are shown for combining horizontal and vertical tillage to solve both weed control, soil pulverization, ground leveling and penetration of the hardpan. In one exemplary embodiment a large colter is disposed behind a plow, sweep, or other horizontal tillage implement to slice the soil to a depth of six inches or more to penetrate a soil compaction layer and a rolling basket follows to level the tilled ground. In another exemplary embodiment, a very large colter is provided with lateral blades to break up crop residue, uproot a significant number of weeds, turn the soil, and penetrate the compaction layer all in one operation. Numerous alternatives are described within the scope of the invention. This horizontal tillage followed by vertical tillage to a depth deeper than that of the horizontal tillage results in good weed control, destruction of the hardpan, good ground leveling and full crop root depth and that should produce increased yields, increased drought resistance and increased wind resistance. In short a better and stronger plant results and that makes a better crop and, hopefully, a better harvest. It is at once a simple but elegant solution that can be done at minimal additional cost.

### DRAWINGS

The invention will be better understood by referring to the attached drawing showing exemplary embodiments.

FIG. 1 is a side elevation view of an exemplary embodiment 100 in an active operational lower position;

FIG. 2 is a side elevation view of embodiment 100 in an inactive raised position;

FIG. 3 is a side elevation view of a second exemplary embodiment 300 in an active operational lower position;

FIG. 4 is a side elevation view of an exemplary embodiment 400 similar to embodiment 300 but rigged for spring tillage and raised into an inactive position;

FIG. 5 is a right side perspective view of a portion of a colter 303 of second exemplary embodiment 300;

FIG. 6 is a side elevational view of an exemplary cultivating unit 600 of an exemplary farm implement 601 having a pair of shank-mounted coulter assemblies 602 and a pair of rolling baskets and

FIG. 7 is a side elevational view of an exemplary preferred “best mode” unit 700 of an exemplary farm implement 701 having a first set of sweeps 704, a second set of sweeps 705, a set of rotary tines 702 and a set of rolling baskets 706.

### DETAILED DESCRIPTION

### First Exemplary Embodiment

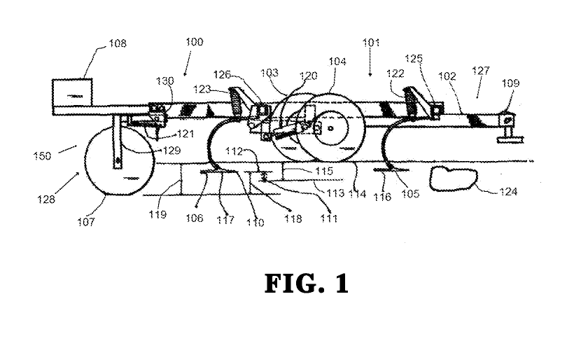

“Coulter” and “colter are used interchangeably to mean a slicing disc used in a farm implement to slice the ground vertically. “Sweep” is used to mean a horizontal blade, either triangular or V-shaped and usually of minimal thickness or height so as to minimize drag, configured for slicing ground in a horizontal plane, the blade typically being attached by a narrow shank to a farm implement. By “horizontal” is also meant at a slight incline or slightly curved yet adapted to be pulled in a horizontal direction. FIG. 1 is a side elevation view of a first exemplary farm tillage implement 100 in an active operational lower position 150. Referring FIG. 1 first, implement 100 is comprises a trailer 102, a left wheel 103, a right wheel 104 a front sweep 105, a rear sweep 106, a colter 107, a weight 108, and a hitch 109. Weight 108 is at the rear of trailer 102 and a hitch 109 is at the front of trailer 102, as shown. Front sweep 105 would be offset to the front and right of rear sweep 106 in conventional manner. Colter 107 is longitudinally aligned directly behind a point 110 of rear sweep 106. While only one unit 101 having one front sweep 105, one rear sweep 106 and one colter 107 are shown, farmers will understand that there would be any desired number of units 101 in a framework 127 by mounted along a front crossbeam 125 and a rear crossbeam 126. The number of such units 101 on framework 127 would be determined by the size of the field in which implement 100 was intended to be used. Colter 107 is provided as a colter assembly 128 including mounting arm 129, spring 121 and bracket assembly 130 suitable for attachment to a standard implement either at the factory or in the field the size of colter 107 would be determined by the depth of penetration which was desired. For example, for spring tillage before planting, a suitable depth of penetration 119 would be within a range of from about 3 to about 8 inches, and preferably within range of from about about 4 to 6 inches. For fall tillage, however, a deeper depth 119 is desired and that might be typically about 8 to 14 inches or more. The size of coulter 107 and the presence or absence of weight 108, and the weight and longitudinal position of weight 108 are adjusted to produce the desired penetration depth 119 for the field conditions in a particular farm and field. Spring 122 and spring 123 provide resilience to sweep 105 and sweep 106 to minimize damage should a rock 124 or other obstacle be encountered.

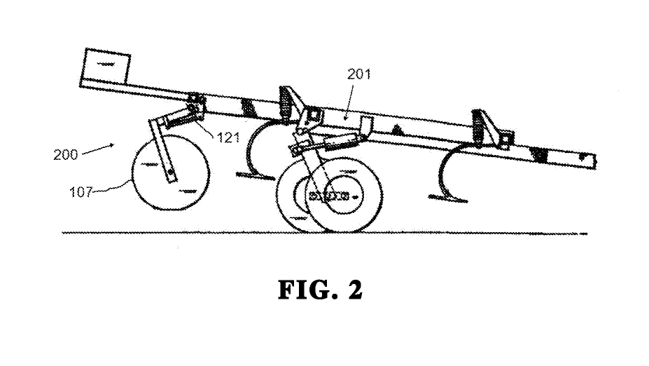

FIG. 2 is a side elevation view of the first exemplary embodiment in an inactive raised position 200. Referring next to FIG. 2, raised position 200 would be used during transit to and from the field and while implement 100 is being properly positioned in the field prior to implement 100 being lowered into lower position 150. Hydraulic piston 120 is in an extended position 201 in order to lower left wheel 103 and right wheel 104 to accomplish this and would be retracted in order to move from raised position 200 to lower position 150. It will also be noted that colter 107 drops down slightly due to its own weight being applied to compress spring 121.

### Operation of First Exemplary Embodiment

The preferred exemplary embodiment is implement 100 shown in FIG. 1 and FIG. 2. Implement 100 uses a colter 107 to break up the typical compaction layer or hard pan 111 that extends downwardly from the level 112 of a bottom 116 of front sweep 105 and a bottom 117 of rear sweep 106 down several inches to a level 113 which lies at a distance 115 of typically about 4-6 inches below the surface 114 of the ground. Front sweep 105 and rear sweep 106 are quite effective at slicing, breaking apart and lifting up the upper several inches of soil and cutting weeds off at their roots. However, front sweep 105 and rear sweep 106 tend to produce a compaction layer or “hardpan” 111 due to the downward pressure on the underlying soil as the front sweep 105 and rear sweep 106 each lifts up the upper layer of soil. Hardpan 111 is a problem for deep-rooted crops such as corn, which have a natural route depth of about 5 to 8 feet. Corn roots have difficulty penetrating hardpan 111. Therefore, corn roots all too often encounter the hardpan and go sideways and end up being very shallow with resultant lowering of yields and with much less resistance to drought and wind. Colter 107 solves this problem by slicing through hardpan 111 to a depth 119 of up to about 4 to 8 inches distance 118 below bottom 116 and bottom 117. Level 112 and depth 119 can be set by adjusting a hydraulic piston 120 to raise or lower left wheel 103 and right wheel 104. Weight 108 holds colter 107 down, while spring 121 extends due to the upward force on colter 107 as colter 107 contacts surface 114. Spring 121 can expand further in response to even greater upward force on colter 107 to provide the resilience that allows colter 107 to move upwardly if it should hit a rock 124 or other similar immovable object. Likewise, spring 122 and spring 123, respectively, allow rear sweep 106 and front sweep 105 to resiliently move upward should they hit rock 124. A ground leveling device such as rolling basket 620 would typically be provided to level the ground following colter 107 so that the field is level for uniform positioning of seed by a planter (not shown). The ground is tilled and leveled in preparation for planting. And, this is all done with an implement 100 that can be run a relatively fast rate through the field.

### Second Exemplary Embodiment

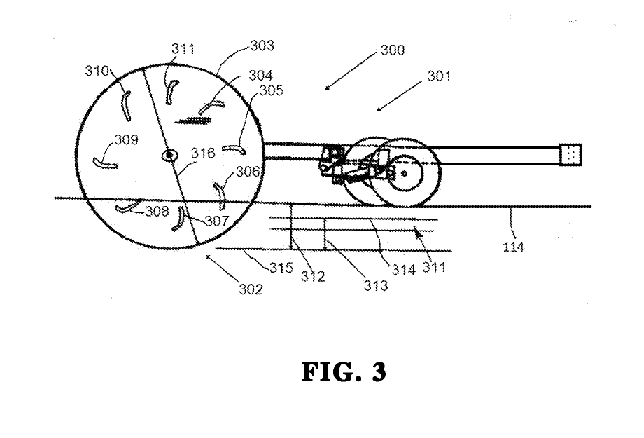

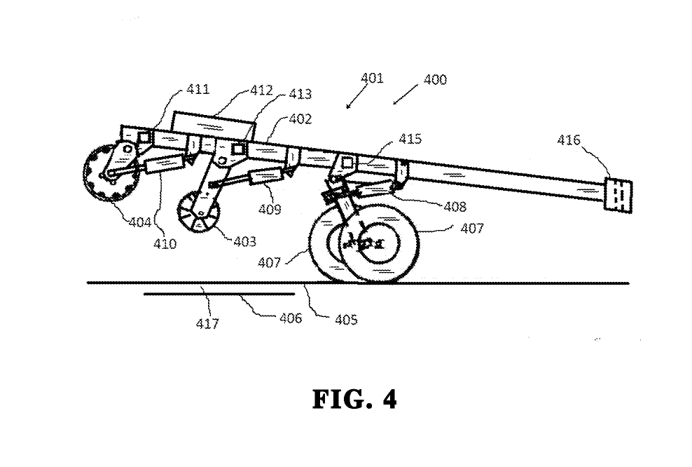

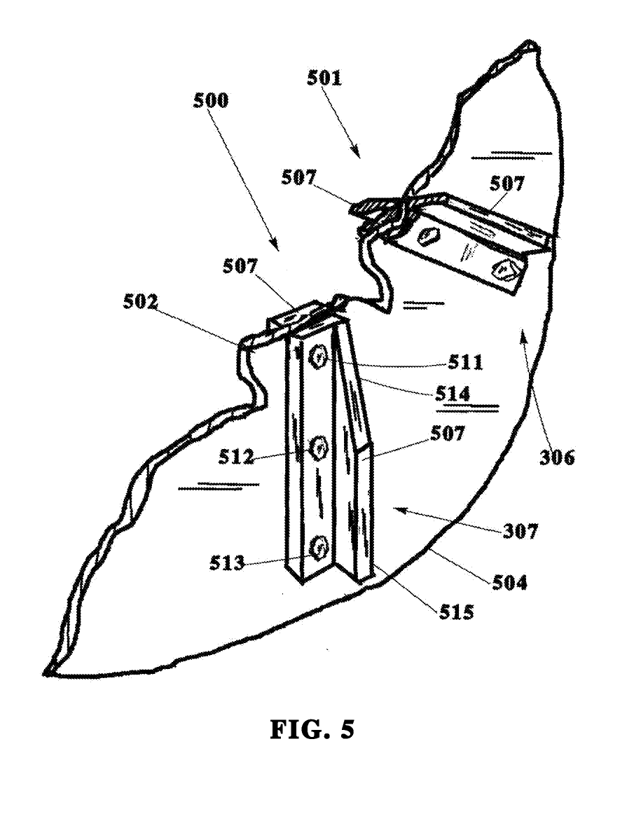

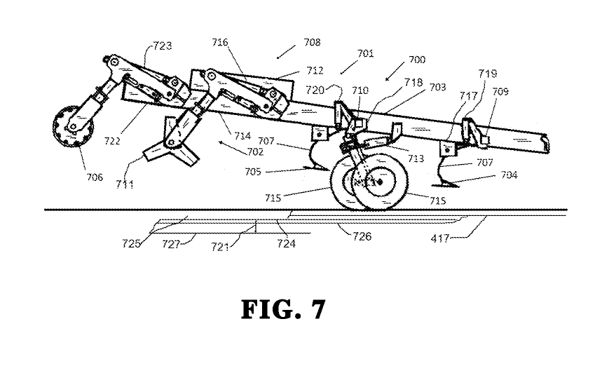

FIG. 3 and FIG. 5 show an alternative exemplary implement 300 with a large bladed coulter 303 configured for fall tillage for breaking up ground near surface 114 and simultaneously penetrating subsoil hardpan 111 while FIG. 4 shows an exemplary embodiment 400 with a smaller bladed coulter 403 rigged for spring tillage to break up surface compaction layers 417 and chop crop residues. FIG. 3 is a side elevation view of one unit 301 of an implement 300 in an active lower position 302. In lower position 302, a unusually large colter 303 is provided which makes unit 301 look much like a monstrous pizza cutter. However unlike a pizza cutter, colter 303 has blade 304, blade 305, blade 306, blade 307, blade 308, blade 309, blade 310 and blade 311, each of which extends laterally from colter 303 and radially along colter 303 to break up the ground while colter 303 is rotating and penetrating to a level 315 that is a depth 312 at a distance 313 below a top 314 of hardpan 111. For easier soil entry, blades 304,305,306,307,308,309,310,311,501 could be angled within a range of from about 5 up to about 15 degrees relative to the radial position shown, or could be curved or tapered or partially radial and partially angled or curved, as found best from usage data in various field conditions. For spring planting a typical depth 312 would be four inches and a typical distance 313 would be two inches, since in spring the farmer is mostly concerned with a few inches of surface crust and surface weeds. So in spring, the top of the compaction layer or hardpan is at the ground surface. In fall tillage, depth 312 might be set at a foot or more and distance 313 might be eight inches, as in fall the crust or hardpan is typically to a depth of 4-8 inches due to tractor passage during chemical applications and harvesting during the growing season. Coulter 303 is so large so that it can perform both spring and fall tillage. If the field is one that has been horizontally tilled for many years without deep vertical tillage, there may be a subsurface hardpan as shown in FIG. 3 even though the top few inches of ground are loosened, so deep penetration with a large diameter colter 303 would be used. This gives an equivalent deep penetration to conventional implements such as chisel point subsoilers and the like to save the farmer having to have a separate subsoiler. The diameter 316 of colter 303 would be preferably 18-30″ for spring tillage, depending on field conditions. For fall tillage, diameter 316 would be similar if just used to eliminate surface compaction layer 417 (see FIGS. 4 and 7) and chop crop residue. If used in fall in place of subsoilers, diameter 316 would be huge relative to traditional colters, up to about 4 to 8 feet, and the precise diameter 316 would depend on how hard it will be to get coulter 303 to go to depths 119 of a foot or more and how heavy and powerful the equipment is that is available to the farmer to drive coulter 303 deeply into the earth. Even with such a large diameter, colter 303 should still roll quite easily across a farm field with blades 304,305,306,307,308,309,310,311,501 breaking up and lifting a massive amount of dirt, penetrating hardpan 111 and rolling easily over rocks 124, as once at speed such large coulters 303 would have substantial inertia. Horizontal sweeps such as sweep 105, sweep 106, sweep 704, and sweep 705 would not be needed as blades 304,305,306,307,308,309,310,311,501 will slice and lift soil and chop crop residue and centrifugal force should expel the lifted dirt nicely provided the dirt is not too muddy. Weeds are not such a concern in the fall as weeds are not competing with crops in winter. This easy rolling should allow for increased fall tillage speeds so a larger acreage could be tilled in a given amount of time than with other slower methods. Implement 300 will present a very unusual and impressive sight, as it will look like a set of massive pizza cutters being pulled across the farm field with dirt flying behind. A sufficient number of colters 107 could be provided to overlap and till the entire field or colters 107 could be just used in the position where it is expected that seeds would be planted, that is, one colter 303 per row of crops with sweeps (not shown) offset between colters 107 for cutting weeds between rows.

FIG. 4 is a side elevation view of a unit 401 of an implement 400 similar to implement 300 but rigged for spring tillage with a much smaller bladed colter 403 and a rolling basket 404. Since FIG. 3 shows exemplary embodiment 300 in an active cultivating position, FIG. 4 shows unit 401 in an inactive raised position for transit to and from the field and while positioning implement 400 prior to lowering implement 400 to lower position which places colter 403 at a depth 406 sufficient to break up a surface compaction layer 417 between soil surface 405 and depth 406. A suitable weight 412 is provided to hold colter 303 down when cultivating. The round nature of colter 303 allows colter 303 to more easily roll over objects like rock 124. A hydraulic piston 408 is retracted to raise wheels 407 move implement 400 from the upper position shown to a lower position and piston 408 is extended to raise implement 400. Hydraulic actuator 409 is retracted to lower and extended to raise colter 403 to, respectively increase and decrease the depth of penetration 406. Likewise, hydraulic actuator 410 is retracted to lower and extended to raise basket 404. Either actuators 409 or 410, or both, could each be replaced by a spring for simplicity, with such a spring having a tension set for holding colter 403 or basket 404 in the desired position except when an obstacle such as rock 124 is struck and yielding resiliently to allow passage over such obstacle. Wheels 407, colters 403 and basket 404 could either be mounted on longitudinal rails 402 or on cross rails 415, 413 and 411, respectively. A hitch 416 is provided to allow attachment of rail 402 to a tractor hitch (not shown).

FIG. 5 is a right side perspective view of a blade portion 500 of colter 303, showing details of blade 306 and blade 307, as well as opposed blade 501 and blade 502. Blade 307 is typical, and it will be understood from the following description that blades 304,305,306,307,308,309,310,311,501-502 would be similar. Blade 307, blade 306, blade 502, and blade 501 are each an L-shaped metal bar 507 disposed near an outer edge 504 of colter 303 and secured by bolt 511, bolt 512 and bolt 513 blades 304,305,306,307,308,309,310,311,501 and blades 501-501 are installed in opposed pairs with bolts 511-513 passing through colter 303 to attach each pair of opposed blades 304-311 and 501-502. Alternately, blades 304,305,306,307,308,309,310,311,501-502 could be permanently attached, such as by being forged integral with coulter 303, permanently bolted to colter 303, or welded to colter 303, or other equivalent permanent attachment method. Blade 307 extends generally radially along a side of colter 303 and is tapered at its radially inward outer portion 514, since radially outward end 515 will do most of the soil penetrating and lifting work. Tapering radially inward outer portion 514 should reduce the amount of crop reside getting tangled on metal bar 507. Also, while bar 507 is shown disposed radially, bar 507 for simplicity in drawing, bar 507 could be angled or curved to make end 515 have a more vertical initial contact with ground during use to make penetration of crusty hard ground easier. At the present time, it is thought that a slight angle of 5-15 degrees would be best, although prolonged field experience will determine an optimum angle, and such angle may vary depending on field conditions.

### Operation of Second Exemplary Embodiment

The operation of implement 300 will be readily apparent to any farmer of ordinary experience and skill from the description above. It is to be noted that a colter 303 of this diameter is highly unusual and nonobvious, as is a bladed colter 403. It will be quite a sight to see such massive colters as colters 107 moving across the farm field throwing dirt. Likewise it will be impressive for a farmer to see the high speed at which colters 403 can be run across a field, since the blades 304,305,306,307,308,309,310,311,501-511 offer less resistance to travel than typical horizontal sweeps or plows. Colter 303 will roll along the field penetrating hardpan 111 and tilling the soil. Once these massive colters 107 pass over a field, the hardpan should be effectively gone entirely if the colters 107 overlap. Implements 300 and 400 use overlapping colters 107 so that the entire hardpan is destroyed and the planting tractor could plant the field in whatever configuration of rows was desired. Note that implement 300 and 400 do not generate a compaction layer or hardpan since blades 304,305,306,307,308,309,310,311,501 rotate much like a rotary hoe rather than running horizontally blades 304,305,306,307,308,309,310,311,501 cut into and scoop rather than running horizontally and generating lift by pulling upwardly rather than pressing downwardly like a plow or sweep. When the blades lift soil at the rear during passage that generates a downward pressure at the front to help drive blades into the soil, and centrifugal force from rotation of colters 107 expels the lifted soil. However, even if blade 304-311, preferably slightly angled as described above, might generate a slight hardpan 111, colter 303 slices and thus destroys that hardpan 111. The effect of implement 300 and implement 400 is a combined vertical tillage due to the colter and horizontal tillage due to the blades, with the horizontal action being a combination of cutting and lifting without hardpan generation like a sweep produces.

### Third Preferred Exemplary “Best Mode” Embodiment

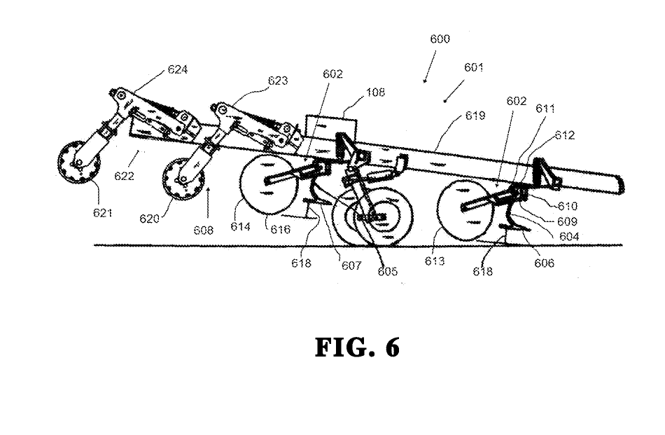

FIG. 6 is a side elevation view of an exemplary unit 600 of an exemplary third farm implement 601 configured for spring tillage with a set of colter assemblies 602, with one assembly 602 attached directly to a front shank 604 of a front sweep 606 and an identical assembly 602 attached to a rear shank 605 of a rear sweep 607. Shank 604 is staggered forwardly and about 6 inches to the right of shank 605. Multiple units 600 would be positioned side by side to comprise implement 601. Implement 601 is shown in a raised position 608 similar in purpose to raised position 200. Implement 601 is similar to implement 100 except that rear assembly 602 substitutes for colter assembly 128 and assembly 602 is also added to front sweep 105 and twin rolling basket 620 and rolling basket 621 are added to rear portion 622 of unit 600. Rolling basket 620 and rolling basket 621 are each carried a hydraulic arm 623 and a hydraulic arm 624, respectively, so they can be raised and lowered to achieve a desired ground pressure. Arm 623 and arm 624 are also staggered, although basket 620 and basket 621 are wider than sweep 606 and sweep 607 so their lateral spacing is greater. Longitudinal spacing of shank 604, shank 605, rolling basket 620 and rolling basket 621 are the same although they are not shown drawn to scale. Farmers typically run a first tilling pass with a tilling implement pulled by a first tractor (not shown)and a second planting pass with a planting implement (not shown) pulled by either the same or a second tractor (not shown). I will describe the attachment of assembly 602 to shank 604. It should be understood that the attachment of assembly 602 to shank 605 would be identical. A right sideplate 609 and a matching left sideplate 610 are on right and left of shank 604 with a bolt 611 and a bolt 612 connecting sideplate 609 to sideplate 610 and pressing sideplate 609 and sideplate 610 against shank 604. So, for this farmer, we provide a simple assembly 602 which can be attached to front shank 604 or rear shank 605. As was the case with colter 107, front and rear colter assemblies 602 would be longitudinally aligned, respectively, with front sweep 606 and rear sweep 607 by virtue of being attached to shank 604 and shank 605.

### Operation of Third Preferred Exemplary Best Mode Embodiment

The operation of implement 601 will be readily apparent to any farmer from FIG. 6 and the preceding description. This is called our “Best Mode” embodiment because it is adaptable to the most farmers and is complete with rolling basket 620 and rolling basket 621 for leveling the ground. Implement 601 is configured for the normal farmer who runs one tractor for tilling and another tractor for planting, where sweep 606 and sweep 607 are staggered and overlapped with a colter assembly 602 attached to the shank of each such sweep so that the entire hardpan is destroyed and all weeds and residue are chopped and the ground is uniformly leveled to provide uniform seed placement. The planting tractor could then plant the field in whatever configuration of rows was desired and the widths of tilling and planting implements would not necessarily have to match. Although weight 108 is shown positioned at the rear (left as shown) of implement 601 to achieve a maximum depth of penetration 119, it is longitudinally adjustable in position. Weight 108 would be moved forward (to the right as shown) and rearward (to the left as shown) along rail 619 to decrease and increase downward force on coulter 613 and coulter 614 to provide the proper force to achieve a desired depth of penetration 119. Also, the vertical position of sideplate 609 and sideplate 610 on shank 604 could be raised or lowered to achieve a desired inactive distance 615 between sweep 606 and the bottom 617 of coulter 613 to even more precisely set the depth of penetration 119 which is depth of vertical tillage. Similarly, position of assembly 602 on shank 605 could be adjusted up or down to achieve a desired distance 618 between sweep 607 and a bottom 616 of colter 614 to set the depth of penetration 119 and the extent to which assemblies 602 cut deeper than sweep 606 and sweep 607 to eliminate any compaction layer produced by sweep 606 and sweep 607.

### Fourth Exemplary “Best Mode” Embodiment

FIG. 7 is a side elevation view of an exemplary unit 700 of an exemplary third farm implement 701 in a raised position and configured for spring tillage with a set of rotary tine assemblies 702 attached to a rail 703 behind a front sweep 704 and a rear sweep 705 and followed by a rolling basket 706. Rail 703 is held down by a weight 712 attached atop a rear portion 714 of rail 703 and is raised and lowered by hydraulic units 713 that are attached to and raise and lower wheels 715. Front sweeps 704 are about 8″ wide and staggered forwardly and about 6 inches to the right of rear sweep 705, which are also about 8″ wide, thus giving a 2″ overlap to assure the entire path of travel of implement 701 is horizontally sliced at the desired depth, typical 4-6″. Multiple units 700 would be spaced side by side to comprise implement 701. Implement 701 is shown in a raised position 708 to allow transport between cultivating operations and would be lowered during cultivation by hydraulic units 713 to a cultivating position (not shown) similar to that shown in FIG. 1. Implement 701 is similar to implement 100 except that tine assembly 702 substitutes for colter assembly 128 and rolling basket 706 to a rear portion 722 of unit 700. In order to provide additional support for assemblies 702, assemblies 702 are attached to rails 703 rather than to a shank 707 of sweep 705 or sweep 704. Rolling basket 706 is similar in structure and purpose to rolling basket 620 and rolling basket 621 and serves to pulverize soil in preparation for spring planting. Basket 706 are either aligned transversely across implement 701, as shown, or staggered. Longitudinal spacing of adjacent rails 703 can be the same or they could be staggered by angling cross rail 709 and cross rail 710 which are, attached to rails 703. Sweeps 704 are mounted on cross rail 709 and sweeps 705 are mounted on cross rail 710. I will describe the attachment of rotary tine assembly 702 to rail 703 So, for this farmer, we provide a simple assembly 702 which can be attached to front rail 703. As was the case with colter 107, tines 711 would be longitudinally aligned, respectively, with front sweep 704 and rear sweep 705 by virtue of being attached to rail 703.

### Operation of Fourth Exemplary “Best Mode” Embodiment

Farmers typically run a first tilling pass with a cultivator pulled by a first tractor (not shown)and a second planting pass with a planter (not shown) pulled by either the same or a second tractor (not shown). The operation of implement 701 will now be described with reference to FIG. 7 and the preceding description. This is called our “Best Mode” embodiment because it is adaptable to many farmers, provides excellent weed control and tillage suitable for most farms with deep rooted crops such as corn and the like. Implement 701 is configured for the normal farmer who runs one tractor for spring till and another tractor for planting. Sweep 704 and sweep 705 are staggered and overlapped with a tine 711 aligned behind each sweep 704 and each sweep 705 so that the entire field can have a surface layer 725 free of weeds by being horizontally sliced at a first depth 724 by overlapping sweeps 704 and sweeps 705. Implement 701 additionally provides rotary tines 711 so that any hardpan 726 resulting from the operation of sweeps 704 and sweeps 705 is penetrated to a second depth 727 by tines 711. First depth 724 is within the range of from about 2″ down to about 4″ and second depth 727 is within the range 721 of from about 4″ down to about 8″ below the surface of the soil Finally, and any clods or clumps are broken up by baskets 706. In this way, the superior weed cutting and breakup of surface compaction layer 417 provided by horizontal tilling is obtained and yet the finished field is, much like in vertical tillage, left without a solid hardpan 726 so that deep root growth is encouraged to obtain better yields from deep-rooted crops such as corn. Weeds and residue are sliced both horizontally and vertically and the ground is uniformly leveled to provide a field ready for uniform seed placement. The planting tractor is then presented with a superior tilled field and can then plant the field in whatever configuration of rows is desired and the widths of tilling and planting implements would not necessarily have to match. Although weight 712 is shown positioned toward a rear portion 722 of implement 701 to achieve a consistently deep first depth 724 and second depth 727, it is longitudinally adjustable in position. Weight 108 would be moved forward (to the right as shown) and rearward (to the left as shown) along rail 703 to decrease and increase downward force to provide the proper force to achieve a desired first depth 724 and second depth 727. Also, the vertical position of sideplate 717 and sideplate 718 on rail 703 could be raised or lowered to even more precisely control the first depth 724 and second depth 727, which is the depth of vertical tillage. Tines 711 are adjusted up or down using pneumatic actuators 716 to set second depth 727. The range 721 can thus be tightly controlled. For example, tines 711 might be set to provide a second depth 727 which is a distance 721 of 2″ deeper than first depth 724 provided by sweeps 704 and sweeps 705. Spring 719 and spring 720 provide resilient upward movement of sweep 704 and sweep 705 should a rock 124 or other similar immovable object be encountered during tillage Finally, the pressure of rolling baskets 706 is set by pneumatic actuators 723, which allows close control of the downward pressure on baskets 706 so that baskets 706 provide good leveling of soil yet do not lift tines 711 undesirably.

### CONCLUSION, CONCERNS, AND CONFINES

Accordingly the reader will see that, according to the invention, I have provided for vertical tillage for reliable destruction of surface compaction down to a depth below the depth of horizontal tillage so the hardpan beneath the crop rows or across the entire field is also destroyed, whichever is the desire of the farmer, and I have done this with a relatively simple modification to existing farm equipment. Embodiments are shown for spring tillage and for fall tillage.

Implement 300 is shown for fall tillage to break up crop residue and prepare the ground for winter without twin rolling baskets 620, 621. Implement 100 is, on the other hand, set for spring tillage, so ground leveling devices such as rolling baskets 620,621 would preferably be added for ground leveling to a more uniform level prior to planting. For many farmers ground leveling devices, such as rolling baskets 706 or are already part of their cultivators so whatever device is already on the cultivator would probably be used instead. Implement 300 uses a large bladed coulter 303 for tillage. This type of large blade coulter might be used for many other tilling applications. For example, a smaller thinner version more like colter 403 might work well for home garden tillers, with the blade size and coulter size configured to achieve a desired depth of penetration with the amount of weight in the tilling unit. Such a garden tiller should roll much easier than existing rotary hoe type garden tillers and might not need a separate motor as it could be pulled by a small yard tractor such as the ubiquitous riding lawn mower.

While the above description contains many specificities, these should not be construed as limitations on the scope of the invention, but in accordance with the principles set for by the US Court of Appeals for the Federal Circuit in Phillips v. AWH Corporation, 415 F.3d 1303 (CAFC 2005), are exemplifications of the presently preferred embodiments thereof intended to meet enablement and best mode requirements of 35 USC 112. The person having ordinary skill in the art will recognize that many other ramifications and variations are possible within the scope of the invention. For example, while deep penetrating colters 107, 303, 613 and 614 are shown, they could be replaced by other ground slicing implements such as knives, narrow chisels, narrow tines, or the like extending slightly deeper than the horizontal tillage devices and slicing any compaction layer created by the horizontal tillage implement immediately below the horizontal tillage implement. For spring tillage prior to planting, it is desired that the ground slicing implement not be a traditional subsoiler or ripper as that would general clods and for the compaction layer we are discussing that would go deeper than we need and be too disruptive. As another exemplary modification, sweep 105, sweep 106, sweep 606, sweep 607, and sweep 317 could each be replaced by any desired horizontal tillage device, such as a plow, horizontal cultivator, Alabama shovel, bladed wing, multi-part sweep-shank-blade, concave disc or the like. The farmer of ordinary skill will understand such horizontal tillage devices. Similarly, while ground leveling is done in implement 601 by hydraulic rolling basket 620 and hydraulic rolling basket 621, other ground leveling devices could be used such as spring mounted rolling baskets, spring tines, drag chains, rotary hoes, spike-tooth harrows, chain harrows, drag bars or skids of various types, and the like. Shank 604 and shank 605 are both shown as C-shanks, but could be S-shanks or simply round or square, curved or straight, solid or tubular shanks and coulter assemblies 602 would be modified as needed for proper attachment and clearance. Colter 613 and colter 614 could be modified by addition of blades similar to blades 304,305,306,307,308,309,310,311,501 for added hoeing, although if ground leveling devices are present, that would normally be unnecessary. Lateral spacing and longitudinal spacing and the number of units 600 in implement 601 could be varied as needed to accommodate differing sizes of sweeps, colters and rolling baskets consistent with the size of the field. Likewise, the lateral spacing, size and number of sweeps, colters, rolling baskets and the like could be varied in implement 100 and implement 300 consistent with the size of the field. While colters 107,303,613,614 are all shown aligned with the direction of travel of their respective implements, they could be mounted in a V-shaped array at an angle relative to the direction of travel and could be individually angled slightly relative to the direction of travel to provide a slight furrowing effect provided they still penetrated to a depth greater than that of the horizontal tillage devices and placed following such devices so as to break up any compaction layer produced immediately below and by such devices.

Thus the scope of the invention and claim construction should be determined broadly by the appended claims and their legal equivalents in view of both intrinsic and extrinsic evidence as to the person having ordinary skill in the art and the broad scope such a person would comprehend consistent with such limitations as are needed to define patentably from the prior art, and not limited to just one or more of the four specific exemplary embodiments given.

1. A soil cultivator, comprising:
1. a leading cultivating device configured to horizontally slice the soil at a first depth below a surface of the soil, and
2. a trailing rolling cultivating device configured to vertically slice the soil to a second depth,
3. said second depth being sufficiently greater than said first depth that said rolling device vertically penetrates any hardpan created by said leading device, whereby to allow deeper root growth of normally deep-rooted planted crops such as corn and the like.

2. The cultivator of claim 1, wherein said first depth is within the range of from about 2″ down to about 4″ and said second depth is within the range of from about 4″ down to about 8″ below the surface of the soil.

3. The cultivator of claim 1, wherein said rolling cultivating device is a rotary tine.

4. The cultivator of claim 1, wherein said rolling cultivating device is a vertical coulter aligned with an intended direction of travel of said cultivator.

5. A soil cultivator which has a rolling colter with laterally and radially extending soil slicing blades, the rolling device configured to penetrate the soil to a depth below a surface compaction layer.

6. The cultivator of claim 3, wherein said depth is within the range of from about 4 to about 8 inches.

7. The cultivator of claim 3, wherein said blades are forwardly inclined within a range of from about 5 degrees to about 15 degrees relative to true radial, whereby to more easily enter said soil.

8. The cultivator of claim 3, wherein said blades are forwardly curved.

9. The cultivator of claim 3, wherein an outer forward end of said curved blades is forwardly inclined within a range of from about 5 degrees to about 15 degrees relative to true radial.
